(19) United States
(12) Patent Application Publication
(10) Pub. No.: US 2021/0245442 A1
(43) Pub. Date: Aug. 12, 2021

(54) THREE-DIMENSIONAL FABRICATING APPARATUS, THREE-DIMENSIONAL FABRICATING SYSTEM, AND FABRICATING METHOD

(71) Applicant: Takahide MAEDA, Kanagawa (JP)

(72) Inventor: Takahide MAEDA, Kanagawa (JP)

(73) Assignee: Ricoh Company, Ltd., Tokyo (JP)

(21) Appl. No.: 17/162,434

(22) Filed: Jan. 29, 2021

(30) Foreign Application Priority Data
Feb. 6, 2020 (JP) 2020-018773

(51) Int. Cl. B29C 64/393; B33Y 10/00; B33Y 30/00; B33Y 50/02; B29C 64/118

(52) U.S. Cl. CPC B29C 64/393; B33Y 10/00; B29C 64/118; B33Y 50/02; B33Y 30/00

(57) ABSTRACT

A three-dimensional fabricating apparatus is configured to fabricate a three-dimensional object with a fabrication material fed at a speed component. The three-dimensional fabricating apparatus includes first correction circuitry, second correction circuitry and a discharger. The first correction circuitry is configured to perform a first correction to emphasize a component in a speed distribution of the speed component. The second correction circuitry is configured to perform a second correction to attenuate a component in the speed distribution. The discharger is configured to discharge the fabrication material fed at a speed based on a corrected speed distribution obtained by the first correction and the second correction.

### CROSS-REFERENCE TO RELATED APPLICATION

This patent application is based on and claims priority pursuant to 35 U.S.C. § 119(a) to Japanese Patent Application No. 2020-018773, filed on Feb. 6, 2020, in the Japan Patent Office, the entire disclosure of which is hereby incorporated by reference herein.

### BACKGROUND

### Technical Field

Embodiments of the present disclosure relate to a three-dimensional fabricating apparatus that enhances accuracy of a shape of a fabricated three-dimensional object, a three-dimensional fabricating system, a three-dimensional fabricating method, and a storage medium storing program code.

### Description of the Related Art

There have been developed fabricating apparatuses (so-called “3D printers”) that fabricate a three-dimensional fabricated object based on input data. Various methods have been proposed as a method of performing three-dimensional fabrication, and examples thereof include a fused filament fabrication (FFF) method.

In fabricating a three-dimensional object by the FFF method, there is known a technology in which a feeding speed of a fabrication material is corrected to compensate for a discharge delay.

### SUMMARY

In an aspect of the present disclosure, a three-dimensional fabricating apparatus is configured to fabricate a three-dimensional object with a fabrication material fed at a speed component. The three-dimensional fabricating apparatus includes first correction circuitry, second correction circuitry and a discharger. The first correction circuitry is configured to perform a first correction to emphasize a component in a speed distribution of the speed component. The second correction circuitry is configured to perform a second correction to attenuate a component in the speed distribution. The discharger is configured to discharge the fabrication material fed at a speed based on a corrected speed distribution obtained by the first correction and the second correction.

In another aspect of the present disclosure, a three-dimensional fabricating system is configured to fabricate a three-dimensional object with a fabrication material fed at a speed component. The three-dimensional fabricating system includes first correction circuitry, second correction circuitry, and a discharger. The first correction circuitry is configured to perform a first correction to emphasize a component in a speed distribution of the speed component. The second correction circuitry is configured to perform a second correction to attenuate a component in the speed distribution. The discharger is configured to discharge the fabrication material fed at a speed based on a corrected speed distribution obtained by the first correction and the second correction.

In still another aspect of the present disclosure, a fabricating method includes fabricating a three-dimensional object with a fabrication material fed at a speed distribution, performing a first correction to emphasize a component in a speed distribution of the speed component, performing a second correction to attenuate a component in the speed distribution, and discharging the fabrication material fed at a speed based on a corrected speed distribution obtained by the first correction and the second correction.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a configuration of a three-dimensional fabricating apparatus according to an embodiment of the present disclosure;

FIG. 2 is a cross-sectional view of a configuration of a head module included in a three-dimensional fabricating apparatus according to an embodiment of the present disclosure;

FIG. 3 is a block diagram of a functional configuration of a three-dimensional fabricating apparatus according to an embodiment of the present disclosure;

FIG. 4 is a perspective view of a configuration example of a mechanism that calculates a discharge speed according to an embodiment of the present disclosure;

FIG. 5 is a diagram of a hardware configuration of a computer serving as a control device that controls a three-dimensional fabricating apparatus according to an embodiment of the present disclosure;

FIGS. 6A and 6B are graphs that illustrate a discharge delay in a comparative example;

FIG. 6C is a diagram that illustrates a discharge delay in the comparative example;

FIG. 7 is a graph that illustrates time response characteristics based on a feeding amount and a discharge amount of a fabrication material according to an embodiment of the present disclosure;

FIG. 8A is a block diagram illustrating a process of an example in which a discharge delay of a fabrication material is corrected in a comparative example;

FIG. 8B illustrates graphs of the example of FIG. 8A in which the discharge delay of the fabrication material is corrected in the comparative example;

FIG. 9 is a block diagram that illustrates a fabricating process in which high-frequency emphasis correction and high-frequency attenuation correction are performed according to an embodiment of the present disclosure;

FIG. 10 is a flowchart of a fabricating process executed by a three-dimensional fabricating apparatus according to an embodiment of the present disclosure;

FIG. 11 illustrates graphs of feeding speeds of a fabrication material after high-frequency emphasis correction and high-frequency attenuation correction have been performed according to an embodiment of the present disclosure;

FIG. 12 is a diagram of examples that compare shapes of a three-dimensional object with and without a high-frequency emphasis correction and a high-frequency attenuation correction according to an embodiment of the present disclosure;

FIG. 13A is a diagram that illustrates filter characteristics according to an embodiment of the present disclosure; and

FIG. 13B is a graph of the filter characteristics illustrated in FIG. 13A.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

Although the present disclosure is hereinafter described with reference to some embodiments, embodiments of the present disclosure are not limited to the embodiments described below. In the drawings referred below, the same reference numbers are used for common elements, and the descriptions thereof are omitted as appropriate. In the following embodiments, as an example of a fabricating system that fabricates by discharging a fabrication material, a three-dimensional fabricating apparatus of a fused deposition fabricating system including a control device that performs fabrication by discharging a fabrication material will be described. However, the fabricating system is not limited to the fabricating system described below. In the embodiment described below, a three-dimensional fabricating apparatus of a fused filament fabrication (FFF) method is described as an example. However, an embodiment of the present disclosure is not particularly limited to the three-dimensional fabricating apparatus of the FFF method, and, for example, a three-dimensional fabricating apparatus of a method that performs fabrication by supplying and discharging a fabrication material other than a filament may be used.

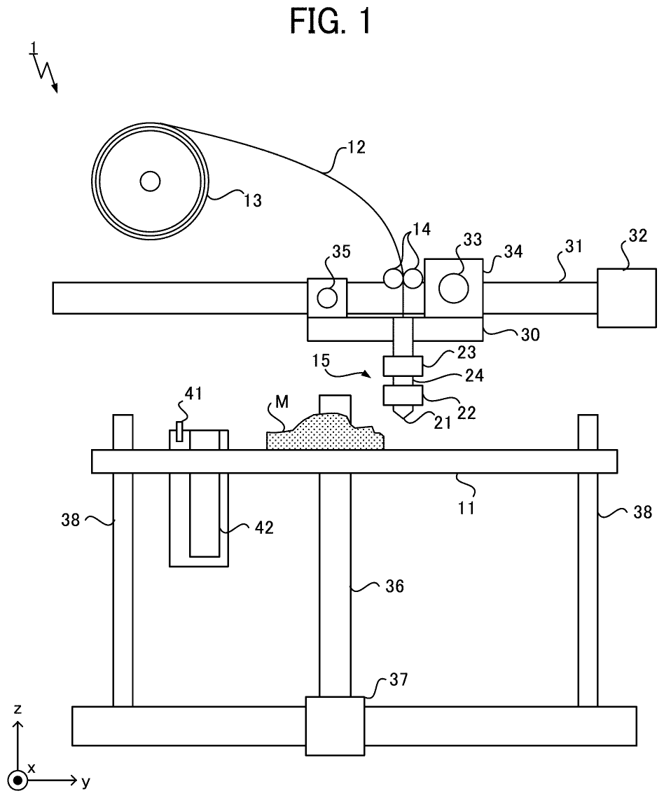

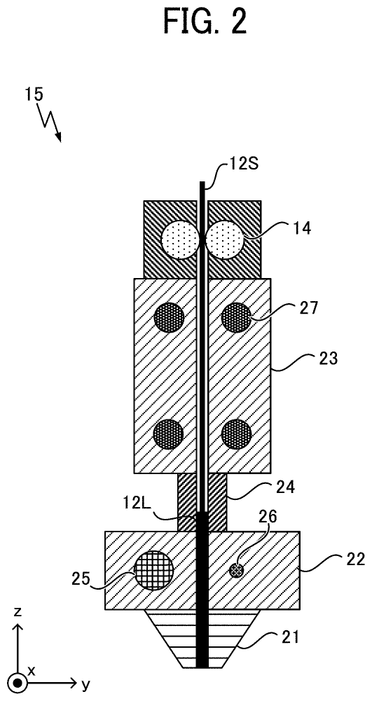

Hereinafter, a basic configuration of a three-dimensional fabricating apparatus 1 according to an embodiment of the present disclosure is described with reference to FIGS. 1 and 2.

FIG. 1 is a diagram of a schematic configuration of the three-dimensional fabricating apparatus 1 according to the present embodiment. An inside of a housing of the three-dimensional fabricating apparatus 1 according to the present embodiment serves as a fabrication space to fabricate a three-dimensional object. As illustrated in FIG. 1, the three-dimensional fabricating apparatus 1 includes a fabrication table 11 as a mounting table, and a three-dimensional object M is fabricated on the fabrication table 11. A head module 15 as a fabrication head is disposed above the fabrication table 11 in the housing of the three-dimensional fabricating apparatus 1.

The three-dimensional fabricating apparatus 1 includes a reel 13 and an extruder 14. The reel 13 that reels a filament 12 is attached outside of the housing of the three-dimensional fabricating apparatus 1. The extruder 14 is provided above the head module 15. The filament 12 is pulled by rotation of the extruder 14 to allow the reel 13 to rotate without exerting a large resistance force.

FIG. 2 illustrates a configuration of the head module 15 according to an embodiment of the present disclosure. As illustrated in FIGS. 1 and 2, the head module 15 includes a discharge nozzle 21 in a lower portion of the head module 15. The discharge nozzle 21 is a discharger to discharge the filament 12 as a fabrication material. The head module 15 includes a heating block 22 to heat and melt the filament 12 fed to the discharge nozzle 21. Further, a cooling block 23 is provided above the heating block 22. Such a configuration enables the cooling block 23 to prevent a melted filament 12L from flowing back to an upper part of the head module 15, an increase in resistance in pushing out the filament 12, or clogging in a transfer path due to solidification of the filament 12.

The heating block 22 includes a heat source 25 to generate heat and a thermocouple 26 to detect the temperature of the heating block 22. The heating block 22 heats and melts the filament 12 fed to the discharge nozzle 21. The cooling block 23 is disposed above the heating block 22 and includes cooling sources 27 that use e.g., an air cooling mechanism or a water cooling mechanism as appropriate to prevent the melted filament 12L from flowing back to the upper part in the head module 15. A filament guide 24 that guides the filament 12 to the discharge nozzle 21 is provided between the heating block 22 and the cooling block 23. The discharge nozzle 21 illustrated in FIG. 2 is modularized together with various components such as the heating block 22, the cooling block 23, and the filament guide 24.

The filament 12 is a solid material in an elongated wire shape and is set on the reel 13 of the three-dimensional fabricating apparatus 1 in a wound state. The above-described extruder 14 is provided above the cooling block 23, thus allowing a filament 12S in a solid state to be drawn into the head module 15 and fed to the discharge nozzle 21 of the head module 15 via the transfer path. In the present embodiment, as illustrated in FIG. 2, the filament 12 fed via the transfer path is melted by the heating block 22, and the filament 12L in the melted state is extruded and discharged from the discharge nozzle 21. Thus, layered fabrication structures are sequentially laminated on the fabrication table 11 and the three-dimensional object M is fabricated.

Referring again to FIG. 1, the head module 15 is held by an X-axis drive shaft 33 and a guide shaft 35 that extend in a front-rear direction of the three-dimensional fabricating apparatus 1 (a direction perpendicular to a plane on which FIG. 1 is illustrated, that is, an X-axis direction) so as to be slidable along a longitudinal direction (X-axis direction) of the X-axis drive shaft 33 via an X-drive base 30. The head module 15 is movable in the front-rear direction (X-axis direction) of the three-dimensional fabricating apparatus 1 by the driving force of an X-axis drive motor 34. Further, since the head module 15 is heated to a high temperature by the heating block 22, preferably, the transfer path including the filament guide 24 has low thermal conductivity so that the heat is not easily conducted to the X-axis drive motor 34.

A Y-axis drive motor 32 is held by a Y-axis drive shaft 31 extending in a left-right direction of the three-dimensional fabricating apparatus 1 (left-right direction in FIG. 1, in other words, Y-axis direction) so as to be slidable along the longitudinal direction (Y-axis direction) of the Y-axis drive shaft 31. When the X-axis drive motor 34 is moved along the Y-axis direction by the driving force of the Y-axis drive motor 32, the head module 15 can be moved along the Y-axis direction.

Note that the head module 15 does not necessarily have to move in the direction along the X-axis direction or the Y-axis direction and can be moved in any direction on the XY plane by the X-axis drive motor 34 and the Y-axis drive motor 32 operating simultaneously.

The fabrication table 11 is passed through a Z-axis drive shaft 36 and guide shafts 38 and is held movably along a longitudinal direction (Z-axis direction) of the Z-axis drive shaft 36 with respect to the Z-axis drive shaft 36 extending in a vertical direction of the three-dimensional fabricating apparatus 1 (the vertical direction in FIG. 1, that is, the Z-axis direction). The fabrication table 11 can be moved in the vertical direction (Z-axis direction) of the three-dimensional fabricating apparatus 1 by the driving force of a Z-axis drive motor 37.

The X-axis drive motor 34, the Y-axis drive motor 32, and the Z-axis drive motor 37 are operated to control the movement of the head module 15 and the fabrication table 11, thus allowing the relative three-dimensional positions of the head module 15 and the fabrication table 11 to move to target three-dimensional positions. Note that, in the present embodiment, the relative three-dimensional positions of the head module 15 and the fabrication table 11 are determined by controlling the movement of the head module 15 along the X-axis direction and the Y-axis direction and the movement of the fabrication table 11 along the Z-axis direction. However, embodiments of the present disclosure are not limited to such a configuration. For example, the fabrication table 11 may be fixed and the movement of the head module 15 may be controlled along the X-axis direction, the Y-axis direction, and the Z-axis direction.

The three-dimensional fabricating apparatus 1 illustrated in FIG. 1 further includes a cleaning brush 41 and a dust box 42. When the filament 12 is continuously melted and discharged, the periphery of the discharge nozzle 21 may be contaminated with molten resin. The cleaning brush 41 periodically performs cleaning operation to prevent the resin from sticking to the tip of the discharge nozzle 21. From the viewpoint of preventing the resin from sticking, preferably the cleaning operation is performed before the temperature of the resin is completely lowered. Therefore, a heat-resistant resin is preferably used for the cleaning brush 41. The dust box 42 accommodates polishing powder generated during the cleaning operation. The polishing powder accumulated in the dust box 42 is periodically discarded or a suction path is provided to discharge the polishing powder to the outside.

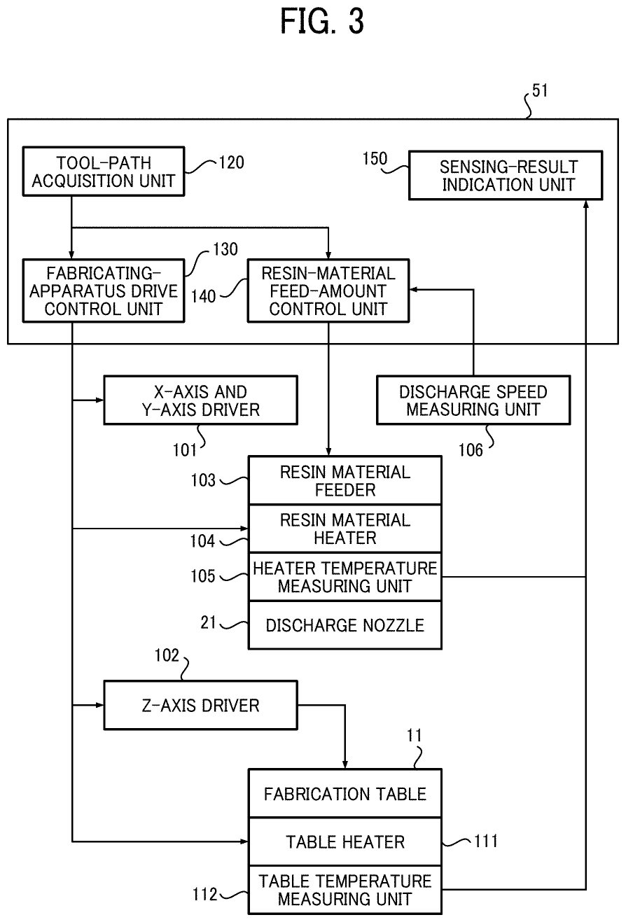

Hereinafter, software blocks constituting the three-dimensional fabricating apparatus 1 according to an embodiment of the present disclosure are described with reference to FIG. 3.

FIG. 3 is a block diagram of a functional configuration of the three-dimensional fabricating apparatus 1 according to an embodiment of the present disclosure. The three-dimensional fabricating apparatus 1 according to the present embodiment includes an X-axis and Y-axis driver 101, a Z-axis driver 102, a resin material feeder 103, a resin material heater 104, a heater temperature measuring unit 105, a discharge speed measuring unit 106, a table heater 111, and a table temperature measuring unit 112.

The three-dimensional fabricating apparatus 1 according to the present embodiment includes a controller 51 that is a control device, and a tool path acquisition unit 120, a fabricating-apparatus drive control unit 130, a resin-material feed-amount control unit 140, and a sensing-result indication unit 150. The controller 51 includes, for example, a central processing unit (CPU) to perform predetermined control arithmetic processing according to programs, a memory to store the programs and various data, and an interface connected to an external device, and achieves functions of the above-described units by collaboration of these units.

The X-axis and Y-axis driver 101 controls the X-axis drive motor 34 and the Y-axis drive motor 32 in accordance with a control signal from the controller 51 to displace the head module 15 to a desired position on the XY plane. The X-axis and Y-axis driver 101 also detects the moving distances of the head module 15 in the X-axis direction and the Y-axis direction and transmits the detection results to the controller 51. The moving speed of the head module 15 can be calculated based on the detection results of the X-axis and Y-axis driver 101. The Z-axis driver 102 controls the Z-axis drive motor 37 based on a control signal from the controller 51 to displace the position of the fabrication table 11 in the Z-axis direction to a desired position.

The resin material feeder 103 feeds the filament 12, which is the fabrication material, to the discharge nozzle 21 with the extruder 14 based on a control signal from the controller 51. The resin material heater 104 heats the temperature of the discharge nozzle 21 and the filament 12 fed to the discharge nozzle 21 to a desired temperature based on a control signal from the controller 51. The heater temperature measuring unit 105 detects the temperature of the resin material heater 104 or a temperature related to the resin material heater 104 and transmits the detection result to the controller 51. In the present embodiment, the temperature of the resin material heater 104 (heating block 22) is detected. However, the temperature of the filament 12 itself or the temperature of the discharge nozzle 21, for example, may be detected.

The table heater 111 heats the fabrication table 11 to a desired temperature based on a control signal of the controller 51. The table temperature measuring unit 112 detects the temperature of the fabrication table 11 or a table temperature that is a temperature related to the fabrication table 11 and transmits the detection result to the controller 51. Examples of the table temperature include the temperature of the fabrication table 11 itself and the temperature of a device (such as an electric heater) that heats the fabrication table 11.

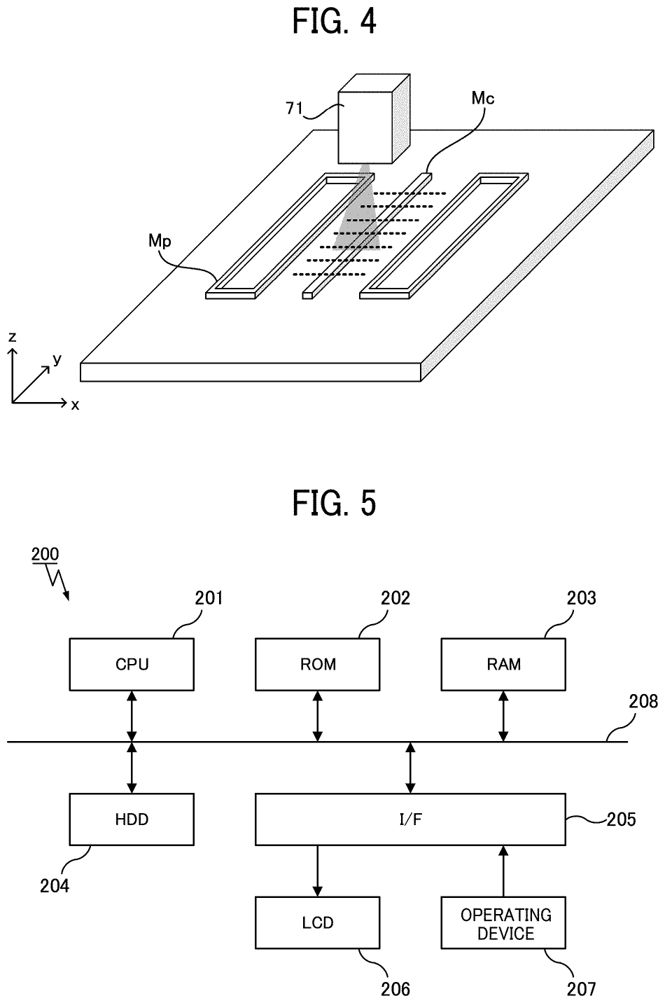

The discharge speed measuring unit 106 measures the speed of the fabrication material (the melted filament 12) discharged from the discharge nozzle 21, and transmits the measurement result to the controller 51. The discharge speed of the fabrication material can be calculated from, for example, the amount of the fabrication material discharged from the discharge nozzle 21 and a temporal change thereof. However, the fabrication material and the discharge nozzle 21 are at high temperatures. Accordingly, directly calculating the discharge speed from the discharge amount is difficult. Therefore, for example, a method of measuring the shape of a fabricated object including one fabrication layer or two or more fabrication layers may be used to calculate the discharge speed. Hereinafter, a method of calculating the discharge speed is described with reference to FIG. 4.

FIG. 4 is a diagram of a configuration example of a mechanism that calculates a discharge speed according to an embodiment of the present disclosure. FIG. 4 illustrates a calibration object Mc, a position reference object Mp, and a measuring device 71. The calibration object Mc is an object to be measured in the measurement to calculate the discharge speed. The position reference object Mp is an object used to check a discharge start position and a discharge finish position of the calibration object Mc. The measuring device 71 is a device that measures the shape of the calibration object Mc, and constitutes the discharge speed measuring unit 106. Note that the shapes of the calibration object Mc and the position reference object Mp are not limited to the shapes illustrated in FIG. 4, and may be any shapes.

Preferably, the calibration object Mc is directly formed on the fabrication table 11 and is formed so as not to contact other objects. This is because if there is another fabricated object that contacts the calibration object Mc, separating the calibration object Mc from the other fabricated object becomes difficult and information relating to the discharge amount may not be accurately measured. For example, when the calibration object Mc is formed on a lower layer formed of another fabricated object, the boundary between the calibration object Mc and the lower layer becomes unclear due to the influence of the roughness of a surface shape of the lower layer.

The measuring device 71 measures a cross-sectional area of the calibration object Mc in a direction perpendicular to the movement direction of the discharge nozzle 21 (in other words, a direction indicated by each broken line in the example of FIG. 4). The discharge speed measuring unit 106 divides the measured cross-sectional area by the moving speed of the discharge nozzle 21, thereby calculating the temporal change of the discharge amount, that is, the discharge speed. The measuring device 71 may be, for example, an optical three-dimensional shape measuring device or a contact shape measuring device.

The description returns to FIG. 3. The tool path acquisition unit 120 acquires tool path data via a network or the like. In the present embodiment, the tool path data refers to data (for example, a G code) for operating the head module 15, which is obtained by slicing each layer from three-dimensional data (for example, data in a stereolithography (SLT) format) for forming a desired three-dimensional object M.

The resin-material feed-amount control unit 140 determines a resin feed amount based on the tool path data and controls the resin material feeder 103. The resin-material feed-amount control unit 140 according to the present embodiment determines a final resin feed amount based on the resin feed amount determined in accordance with the tool path data and further based on the discharge speed measured by the discharge speed measuring unit 106. In the present embodiment, the resin feed amount is an operable amount such as a linear speed of the filament 12.

The fabricating-apparatus drive control unit 130 transmits control signals to the X-axis and Y-axis driver 101 and the Z-axis driver 102 to control the movement of the head module 15 and the fabrication table 11, thereby moving the relative three-dimensional positions of the head module 15 and the fabrication table 11 to target three-dimensional positions. The sensing-result indication unit 150 displays, for example, a result detected by the heater temperature measuring unit 105 or the table temperature measuring unit 112.

Note that the software blocks described above correspond to functional units implemented by a controller such as a CPU executing a program according to the present embodiment to function each hardware. All the functional units illustrated in each embodiment may be implemented in software, or part or all of the functional units may be implemented as hardware that provides equivalent functions.

Furthermore, all of the functional units described above may not be included in the configuration illustrated in FIG. 3. For example, in another embodiment, some functional units of the controller 51 may be included in an information processing apparatus such as a personal computer terminal connected to the outside of the three-dimensional fabricating apparatus 1, and the three-dimensional fabricating apparatus 1 and the information processing apparatus may cooperate with each other to realize a fabricating system.

Next, with reference to FIG. 5, a hardware configuration of an external computer as a control device is described. FIG. 5 is a diagram of an example of a hardware configuration of a computer 200 as a control device that controls the three-dimensional fabricating apparatus 1 according to an embodiment of the present disclosure. The computer 200 has the same configuration as a general personal computer. For example, the computer 200 includes a central processing unit (CPU) 201, a read only memory (ROM) 202, a random access memory (RAM) 203, a hard disk drive (HDD) 204, an interface (I/F) 205, a liquid crystal display (LCD) 206, and an operating device 207. The CPU 201, the ROM 202, the RAM 203, the HDD 204, and the I/F 205 are connected to each other via a bus 208. The HDD 204 may be any other storage device such as a solid state drive (SSD) as long as it is a nonvolatile storage device.

The CPU 201 is an arithmetic unit and controls the entire operation of the computer 200. The ROM 202 is a read-only nonvolatile storage medium and stores programs such as a boot program and firmware for controlling hardware. The RAM 203 is a volatile storage medium capable of high-speed reading and writing of information, and is used as a work area when the CPU 201 processes information. The HDD 204 is a non-volatile storage medium capable of reading and writing information, and stores an operating system (OS), various programs, various data, and the like.

The I/F 205 connects the bus 208 to various hardware, networks, and the like, and controls such as input and output of information and transmission and reception of information. The I/F 205 can include a network I/F for allowing the computer 200 to communicate with other apparatuses via the network. As the network I/F, Ethernet (registered trademark), a universal serial bus (USB) interface, or the like can be used. The LCD 206 is a visual user interface to check the state of the computer 200, and the operating device 207 is a user interface such as a keyboard or a mouse to input information to the computer 200.

The computer 200 includes functional units that implement various functions as the

CPU 201 performs an arithmetic operation according to a program stored in the ROM 202 or a program read from the HDD 204 or a storage medium such as an optical disc to the RAM 203. Note that all of the functional units may be implemented by execution of the program, or a part of the functional units may be implemented by execution of the program and the other part of the functional units may be implemented by hardware such as a circuit, or all of the functional units may be implemented by hardware.

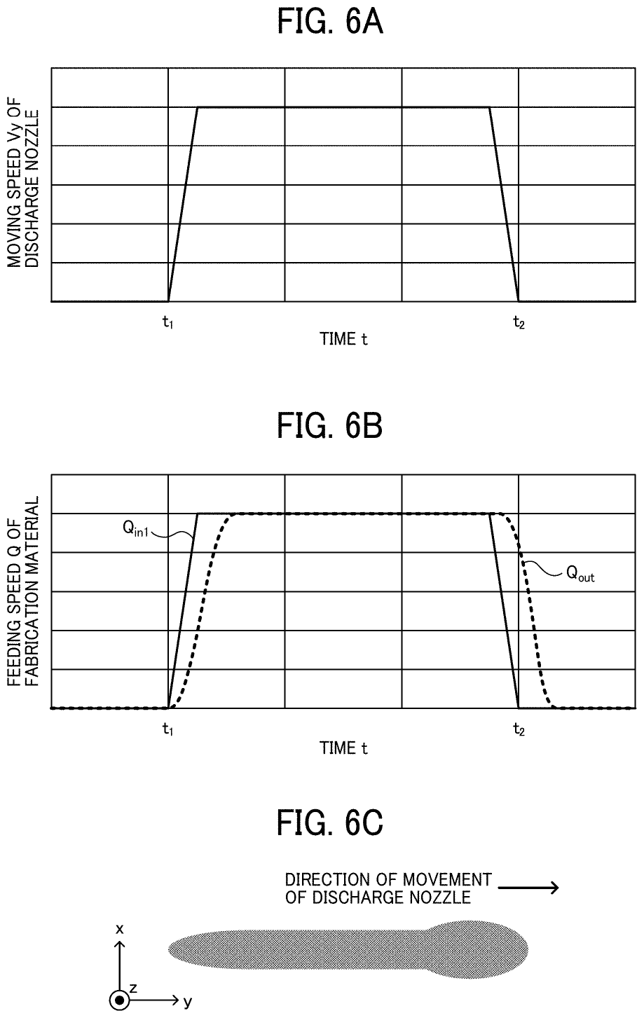

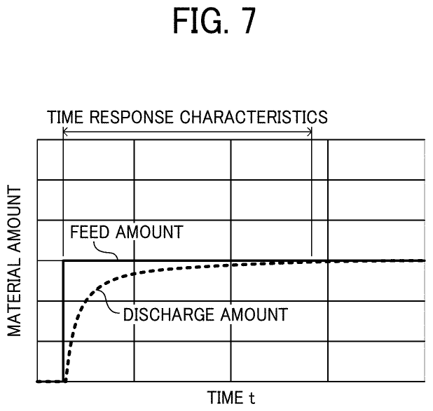

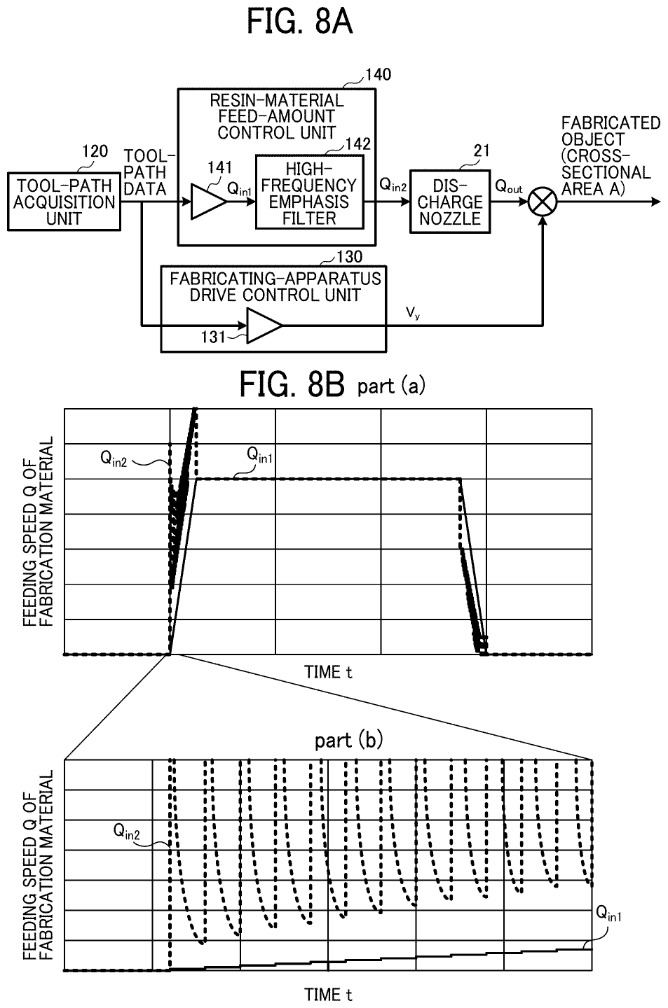

In the present embodiment, a discharge delay of the fabrication material and the correction of the discharge delay in a comparative example will be described with reference to FIGS. 6A, 6B, 6C, 7, 8A, and 8B. FIGS. 6A and 6B are graphs that explain a discharge delay in the comparative example. FIG. 6C is a diagram that illustrates the discharge delay in the comparative example. FIG. 7 is a graph of time response characteristics based on the feed amount and the discharge amount of the fabrication material. FIG. 8A is a block diagram and FIG. 8B illustrates graphs of an example in which the discharge delay is corrected in the comparative example.

First, a description is given with reference to FIGS. 6A, 6B, and 6C. FIG. 6A illustrates a time distribution of the moving speed of the discharge nozzle 21 controlled by the fabricating-apparatus drive control unit 130 based on the tool path data. In FIG. 6A, the horizontal axis represents time t and the vertical axis represents moving speed V_{y} of the discharge nozzle 21. As illustrated in FIG. 6A, the discharge nozzle 21 starts moving at time t1 and accelerates at a constant speed until reaching a predetermined speed. After moving at the predetermined speed, the discharge nozzle 21 decelerates at a constant acceleration and stops moving at time t2. FIG. 6A illustrates an example in which the discharge nozzle 21 moves parallel to the Y-axis. However, embodiments of the present disclosure are not limited to the example, and the discharge nozzle 21 can move in any direction.

FIG. 6B illustrates a speed indicating a time distribution of the feeding speed Qᵢₙ of the fabrication material and the discharge speed Qₒᵤₜ of the fabrication material. In FIG. 6B, the horizontal axis represents the time t and the vertical axis represents the feeding speed Q of the fabrication material. In FIG. 6B, the solid line indicates the feeding speed Qᵢₙ of the fabrication material, and the broken line indicates the discharge speed Qₒᵤₜ of the fabrication material. The feeding speed Qᵢₙ of the fabrication material corresponds to the speed at which the filament 12 as the fabrication material is fed by the extruder 14, and can be calculated from the rotation amount per unit time of the extruder 14 as an example. The discharge speed Qₒᵤₜ of the fabrication material is a value measured by the discharge speed measuring unit 106.

As illustrated in FIG. 6B, the feeding of the fabrication material is started at the time t1 and is stopped at the time t2 after being supplied at a predetermined speed for a certain period of time. When the fabrication material is fed in this manner, the fabrication material is melted and compressed by its viscosity, and thus the discharge speed Qₒᵤₜ is delayed with respect to the feeding speed Qᵢₙ. Even while the discharge speed is delayed, the discharge nozzle 21 moves as illustrated in FIG. 6A. Thus, the shape of the fabricated object in a linear shape is not uniform and disturbance of the shape occurs. FIG. 6C is a top view of the shape of the fabricated object. The shape of a portion of the fabricated object in the vicinity of the discharge start end and the shape of a portion of the fabricated object in the vicinity of the discharge finish end are disturbed.

The discharge delay can be compensated based on various data such as time response characteristics from when an input command is issued until the output discharge amount is stabilized, a gain indicating an amplitude of the output with respect to an input command value, the time response characteristics, and a frequency response indicating a difference between frequencies of the gain. The time response characteristics indicate behavior of the three-dimensional fabricating apparatus 1 from the start of control until a predetermined amount of the fabrication material is stably discharged in a case in which a control to feed the predetermined amount of the fabrication material (feed amount) is performed. For example, FIG. 7 is a graph that illustrates the time response characteristics based on the feed amount and the discharge amount of the fabrication material. In FIG. 7, the horizontal axis represents the time t, and the vertical axis represents the amount of the fabrication material. A solid line and a broken line in FIG. 7 indicate a temporal change in the feed amount and a temporal change in the discharge amount of the fabrication material, respectively. In FIG. 7, the time response characteristics are indicated by a time until the discharge amount reaches a predetermined amount of the fabrication material.

The data that compensates for the discharge delay can be efficiently acquired by using, for example, a step input or a sine wave input. The step input corresponds to a response at the time when the discharge of the fabrication material is on or off. Thus, a gain and a time constant can be acquired. The sine wave input corresponds to a periodic change in the feed amount of the fabrication material during fabrication. Thus, a change in the gain or the time constant due to the frequency can be acquired. In this manner, the discharge delay can be compensated based on the data obtained by the step input or the sine wave input.

Next, FIGS. 8A and 8B are described. In FIGS. 8A and 8B, a correction that emphasizes a high-frequency component is performed on the feeding speed Q of the fabrication material to compensate for the discharge delay. FIG. 8A is a block diagram illustrating a process in which a high-frequency emphasis correction is performed for fabrication. As illustrated in FIG. 8A, the tool path data acquired by the tool path acquisition unit 120 is input to the fabricating-apparatus drive control unit 130 and the resin-material feed-amount control unit 140. The tool path data input in FIG. 8A is, for example, data of a case in which a linear fabrication layer parallel to the Y-axis direction illustrated in FIG. 6C is fabricated. The fabricating-apparatus drive control unit 130 includes a conversion unit 131. The conversion unit 131 outputs the movement speed V_{y} of the discharge nozzle 21 based on the tool path data.

The resin-material feed-amount control unit 140 includes a conversion unit 141 and a high-frequency emphasis filter 142. The conversion unit 141 outputs the feeding speed Qᵢₙ₁ of the fabrication material based on the tool path data. The high-frequency emphasis filter 142 as a first correction unit or circuitry performs correction to emphasize predetermined components of the feeding speed Qᵢₙ₁ of the fabrication material as speed components. More specifically, the high-frequency emphasis filter 142 is a filter that corrects the feeding speed Qᵢₙ₁ of the fabrication material in accordance with an acceleration, and emphasizes components having a large rate of change in speed over time, that is, high frequency components of the feeding speed Qᵢₙ₁ of the fabrication material. As a result, a delay in discharge of the fabrication material with respect to the feeding of the fabrication material can be compensated. The high-frequency emphasis filter 142 outputs an emphasis-corrected signal Qᵢₙ₂. The fabrication material is fed to the discharge nozzle 21 at the output feeding speed Qᵢₙ₂ and discharged at the discharge speed Qₒᵤₜ.

When the discharge nozzle 21 discharges the fabrication material at the discharge speed Qₒᵤₜ while moving at the moving speed V_{y}, a linear-shaped object having a cross-sectional area A is fabricated.

Part (a) of FIG. 8B is a graph that illustrates the feeding speed Q of the fabrication material before and after the frequency emphasis correction is applied. A solid line in part (a) of FIG. 8B represents the feeding speed Qᵢₙ₁ of the fabrication material before the high-frequency emphasis correction, and corresponds to the feeding speed Qᵢₙ₁ of the fabrication material illustrated in FIG. 6B. A broken line in part (a) of FIG. 8B represents the feeding speed Qᵢₙ₂ of the fabrication material after the high-frequency emphasis correction has been applied. The feeding speed Qᵢₙ₁ of the fabrication material is converted from the tool path data by digital signal processing using a field programmable gate array (FPGA) or the like. Therefore, the temporal speed change of the feeding speed Qᵢₙ₁ of the fabrication material is a discrete change. When the high-frequency emphasis correction is performed on the feeding speed Qᵢₙ₁ of the fabrication material that changes discretely in this manner, a change point of the value of the feeding speed Qᵢₙ₁ is treated as a point having a large acceleration and emphasized. Thus, the speed fluctuation of the feeding speed Qᵢₙ₂ of the fabrication material after the high-frequency emphasis correction has been applied becomes large.

Part (b) of FIG. 8B is an enlarged graph of the vicinity of a time when the feeding of the fabrication material is started in part (a) of FIG. 8B. As illustrated in part (b) of FIG. 8B, the feeding speed Qᵢₙ₁ of the fabrication material discretely changes before the high-frequency emphasis correction is applied. Accordingly, if the high-frequency emphasis correction is applied, the speed fluctuation of the feeding speed Qᵢₙ₂ of the fabrication material becomes unstable. When the fluctuation of the feeding speed Qᵢₙ₂ of the fabrication material becomes unstable in this way, the behavior of the extruder 14 finely fluctuates. Accordingly, the fabrication material is not appropriately discharged, or the load of the motor increases. As a result, the fabrication accuracy may decrease, and a three-dimensional object having a desired shape may not be fabricated.

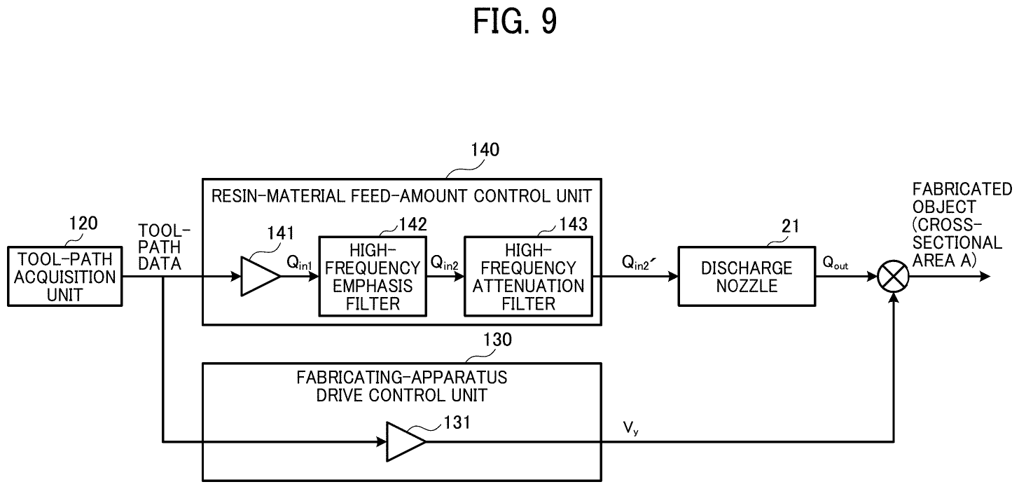

Therefore, in the present embodiment, high-frequency emphasis correction and high-frequency attenuation correction are applied with respect to the feeding speed Q of the fabrication material. FIG. 9 is a block diagram of a process in which high-frequency emphasis correction and high-frequency attenuation correction are applied for fabrication in the present embodiment.

As illustrated in FIG. 9, the resin-material feed-amount control unit 140 according to the present embodiment includes the conversion unit 141, the high-frequency emphasis filter 142, and a high-frequency attenuation filter 143. The conversion unit 141 and the high-frequency emphasis filter 142 have the same configurations as those described in FIG. 8A. Accordingly, detailed description thereof will be omitted. The high-frequency emphasis filter 142 as a first correction unit or circuitry performs correction to emphasize predetermined components of the feeding speed Qᵢₙ₁ of the fabrication material as speed components. The high-frequency attenuation filter 143 as a second correction unit or circuitry performs correction to attenuate predetermined components of the feeding speed Qᵢₙ₂ of the fabrication material as speed components. More specifically, the high-frequency attenuation filter 143 is a so-called low-pass filter, and attenuates high-frequency components in the distribution of the feeding speed Q of the fabrication material. Such a configuration can restrain the speed variation caused by the high-frequency emphasis correction. Note that the high-frequency emphasis filter 142 and the high-frequency attenuation filter 143 can be configured as digital filters as an example. However, embodiments of the present disclosure are not particularly limited to such a configuration and any filters may be used as long as the filters can perform high-frequency emphasis correction or high-frequency attenuation correction. For example, the number of stages or the order of the filters may be any number. As a smoothing method for the high-frequency attenuation filter 143, any method such as a method of taking a differential of acceleration or a method of taking an average value from a correction history can be adopted.

The conversion unit 141 of the resin-material feed-amount control unit 140 outputs the feeding speed Qᵢₙ₁ of the fabrication material based on the tool path data. Next, the high-frequency emphasis filter 142 emphasizes high frequency components of the feeding speed Qᵢₙ₁ of the fabrication material and outputs the feeding speed Qᵢₙ₂ of the fabrication material. Thereafter, the high-frequency attenuation filter 143 performs correction to attenuate high-frequency components of the feeding speed Qᵢₙ₂ of the fabrication material, and outputs a feeding speed Qᵢₙ₂′ of the fabrication material. The fabrication material is fed to the discharge nozzle 21 at the output feeding speed Qᵢₙ₂′ and discharged at the discharge speed Qₒᵤₜ.

The conversion unit 131 of the fabricating-apparatus drive control unit 130 outputs the movement speed V_{y} of the discharge nozzle 21 based on the tool path data. The discharge nozzle 21 discharges the fabrication material at the discharge speed Qₒᵤₜ while moving at the movement speed V_{y}, thereby fabricating the linear-shaped object having the cross-sectional area A.

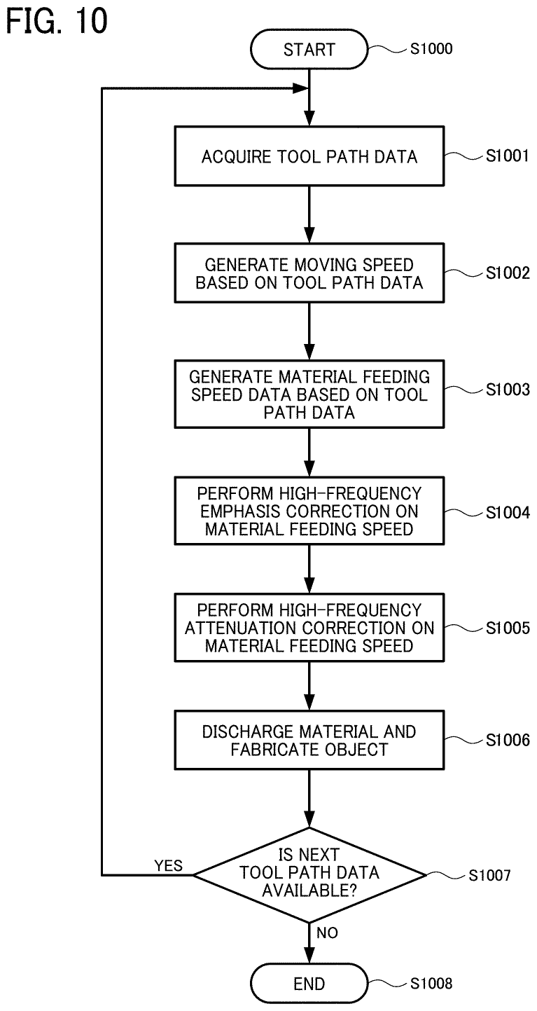

FIG. 10 is a flowchart of a fabrication process performed by the three-dimensional fabricating apparatus 1 according to an embodiment of the present disclosure. The three-dimensional fabricating apparatus 1 starts the fabrication process from step S1000. In step S1001, the tool path acquisition unit 120 acquires tool path data to fabricate a desired three-dimensional object. In FIG. 10, a desired three-dimensional object is fabricated by repeating fabrication steps based on a plurality of tool path data.

Next, in step S1002, the fabricating-apparatus drive control unit 130 generates the moving speed V_{y} of the discharge nozzle 21 from the tool path data acquired in step S1001.

In step S1003, the conversion unit 141 of the resin-material feed-amount control unit 140 generates the feeding speed Qᵢₙ₁ of the fabrication material based on the tool path data. In step S1004, the high-frequency emphasis filter 142 as the first correction unit or circuitry applies high-frequency emphasis as a correction to emphasize predetermined components of the feeding speed Qᵢₙ₁ generated in step S1003. Then, the feeding speed Qᵢₙ₂ after the high-frequency emphasis correction is output. In step S1005, the high-frequency attenuation filter 143 as the second correction unit or circuitry applies a high-frequency attenuation as a correction to attenuate predetermined components of the feeding speed Qᵢₙ₂ to which a high-frequency emphasis has been applied, and outputs a feeding speed Qᵢₙ2′ to which high-frequency attenuation correction has been applied. The processing of step S1002 and the processing of steps S1003, S1004, and S1005 may not necessarily be performed in the order illustrated in FIG. 10, and may be performed in parallel.

Thereafter, in step S1006, the fabrication material is discharged based on the movement speed V_{y} and the feeding speed Qᵢₙ₂′ to which the high-frequency attenuation correction has been applied, and the fabrication process is performed. That is, the fabricating-apparatus drive control unit 130 operates the X-axis and Y-axis driver 101 based on the movement speed V_{y}, and the resin-material feed-amount control unit 140 operates the resin material feeder 103 based on the feeding speed Qᵢₙ₂′ of the fabrication material.

In step S1007, the process branches depending on whether next tool path data is available. If the next tool path data is available (YES in step S1007), the process returns to step S1001. Therefore, the three-dimensional fabricating apparatus 1 repeats the processing of steps S1001 to S1006 for all tool path data. On the other hand, when no next tool path data is available (NO in step S1007), the process proceeds to step S1008, and the three-dimensional fabricating apparatus 1 ends the process.

According to the process illustrated in FIG. 10, the discharge nozzle 21 can perform the fabrication process while compensating for the discharge delay of the fabrication material and restraining the speed fluctuation of the feeding speed of the fabrication material. Thus, the fabrication accuracy of the shape of the three-dimensional object can be enhanced.

The flowchart illustrated in FIG. 10 is an example and does not particularly limit the embodiments of the present disclosure. Therefore, for example, the steps S1004, S1005, and S1006 at relatively short time intervals of about several microseconds to several milliseconds may be repeated to sequentially perform the high-frequency emphasis correction and high-frequency attenuation correction while performing fabrication. However, the above-described process is an example of the embodiments according to the present disclosure and a process other than the above-described processing may be employed.

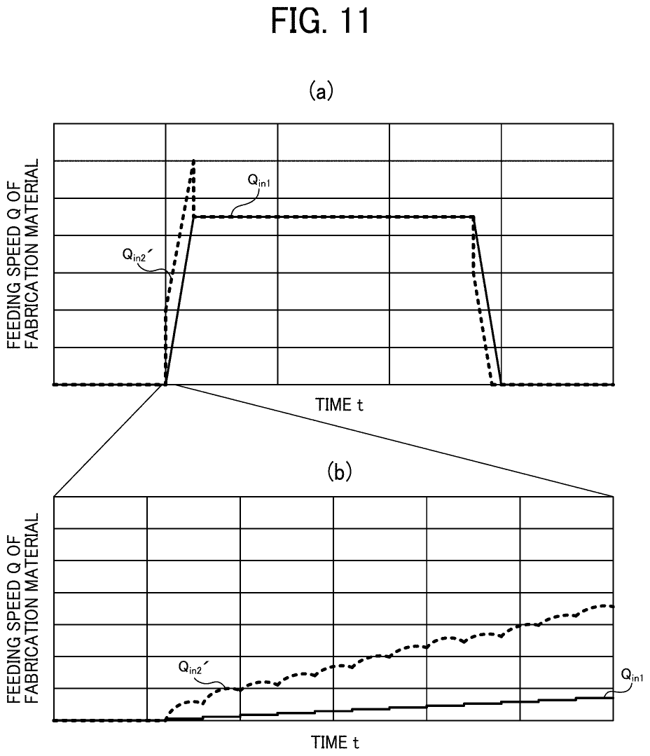

Part (a) and part (b) of FIG. 11 are graphs of the feeding speed Q of the fabrication material to which the high-frequency emphasis correction and high-frequency attenuation correction are applied according to an embodiment of the present disclosure. Part (a) of FIG. 11 is a graph that compares the feeding speed Qᵢₙ₁ of the fabrication material before the high-frequency emphasis and attenuation correction is applied with the feeding speed Qᵢₙ₂′ of the fabrication material after the high-frequency emphasis and attenuation correction has been applied. A solid line in part (a) of FIG. 11 represents the feeding speed Qᵢₙ₁ of the fabrication material before the high-frequency emphasis and high-frequency attenuation correction is applied, and corresponds to the feeding speed Qᵢₙ₁ of the fabrication material in FIGS. 6B and part (a) of FIG. 8B. A broken line in part (a) of FIG. 11 represents the feeding speed Qᵢₙ₂′ of the fabrication material after the high-frequency emphasis correction and the high-frequency attenuation correction have been applied. As illustrated in part (a) of FIG. 11, the fluctuation in the feeding speed of the fabrication material is restrained by the high-frequency emphasis correction and the high-frequency attenuation correction.

Part (b) of FIG. 11 is an enlarged graph of the vicinity of a time when the feeding of the fabrication material is started in part (a) of FIG. 11. As illustrated in part (b) of FIG. 11, the feeding speed Qᵢₙ₁ of the fabrication material before the high-frequency emphasis correction is applied discretely changes. However, the speed fluctuation of the feeding speed Qᵢₙ₁ is restrained by the high-frequency attenuation correction. That is, in the feeding speed Qᵢₙ₂′ of the fabrication material to which the high-frequency attenuation correction is applied after the high-frequency emphasis correction has been applied, the speed fluctuation of the feeding speed Qᵢₙ₂′ of the fabrication material with respect to the discrete change of the Qᵢₙ₁ is sufficiently restrained as compared with the feeding speed Qᵢₙ₂ of the fabrication material to which only the high-frequency emphasis correction is applied as illustrated in part (b) of FIG. 8B. Accordingly, the fabrication material is appropriately fed to the discharge nozzle 21, and the fabrication material can be stably discharged. Thus, the accuracy of the three-dimensional object can be enhanced.

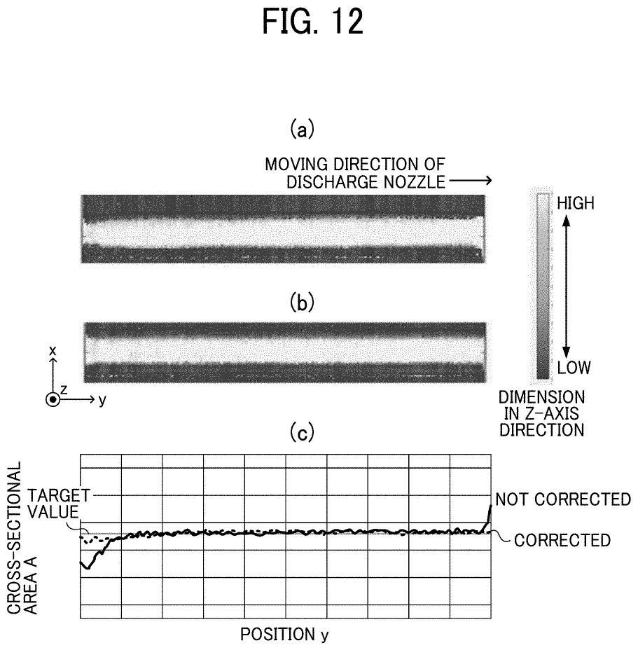

Part (a) and (b) of FIG. 12 are views of an example that compares shapes of a three-dimensional object with and without the high-frequency emphasis correction and the high-frequency attenuation correction according to an embodiment of the present disclosure. Part (a) of FIG. 12 illustrates a height distribution of a fabricated object when fabrication is performed without applying the high-frequency emphasis correction and the high-frequency attenuation correction. Part (b) of FIG. 12 illustrates a dimension (height) distribution in a Z-direction of the fabricated object when fabrication is performed with the high-frequency emphasis correction and the high-frequency attenuation correction applied. Part (c) of FIG. 12 is a graph of cross-sectional area A of the fabricated object. A solid line in part (c) of FIG. 12 represents the cross-sectional area A to which no correction is applied. A broken line represents the cross-sectional area A to which high-frequency emphasis correction and high-frequency attenuation correction are applied. Further, part (c) of FIG. 12 indicates a target value of the cross-sectional area A.

When the high-frequency emphasis correction and the high-frequency attenuation correction are not applied, as illustrated in part (a) and (c) of FIG. 12, the amount of the fabrication material is insufficient in the vicinity of the discharge start end. Thus, the line width is reduced and the cross-sectional area A is equal to or less than the target value. Further, in the vicinity of the discharge finish end, the discharge amount of the fabrication material becomes excessive. Accordingly, the line width becomes thick and the cross-sectional area A becomes equal to or larger than the target value. On the other hand, when the high-frequency emphasis correction and the high-frequency attenuation correction are applied, as illustrated in part (b) and (c) of FIG. 12, the line width is formed to be substantially constant, and the cross-sectional area A close to the target value is obtained from the discharge start end to the discharge finish end. Therefore, applying the high-frequency emphasis correction and the high-frequency attenuation correction according to the present embodiment enables the accuracy of the shape of the three-dimensional object to be enhanced.

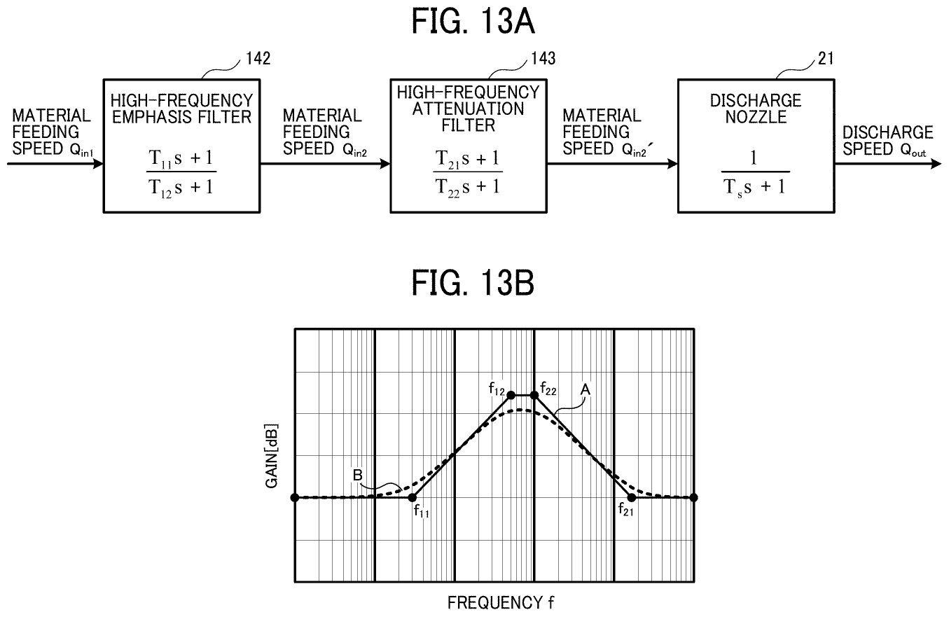

Next, filter characteristics according to an embodiment of the present disclosure are expressed in the form of a transfer function to describe the relationship between the time constant of the discharge delay and the time constants of the high-frequency emphasis filter 142 and the high-frequency attenuation filter 143. FIG. 13A is a diagram and FIG. 13B is a graph that illustrate filter characteristics according to an embodiment of the present disclosure. FIG. 13A is a diagram that illustrates a discharge system of the fabrication material according to the present embodiment expressed by a transfer function. In FIG. 13A, discharge delays caused by the high-frequency emphasis filter 142, the high-frequency attenuation filter 143, and the discharge nozzle 21 are indicated.

As illustrated in FIG. 13A, the transfer function of the high-frequency emphasis filter 142 has delay characteristics including time constants T₁₁ and T₁₂ corresponding to frequencies f₁₁ and f₁₂, respectively. The transfer function of the high-frequency attenuation filter 143 has delay characteristics including time constants T₂₁ and T₂₂ corresponding to frequencies f₂₁ and f₂₂, respectively. When the discharge delay characteristics are expressed as a transfer function of a primary delay system, the time constant of the discharge delay of the entire system can be expressed as Tₛ. S of T₁₁s, T₁₂s, T₂₁s, T₂₂s, and Tₛs in FIG. 13A represents Laplace operators. The Laplace operator is set as s=j wω (j is a symbol of an imaginary number, ω is an angular frequency, and w=2πf) to obtain frequency characteristics such as a gain and a phase.

FIG. 13B is a graph of the filter characteristics according to present embodiment. As indicated by solid line A in FIG. 13B, components higher than f₁₁ as the first frequency are emphasized by the high-frequency emphasis filter 142, and components higher than f₂₂ as the second frequency are attenuated by the high-frequency attenuation filter 143. As illustrated in FIG. 13B, the second frequency f₂₂ is higher than the first frequency f₁₁. Therefore, the filter characteristics of the entire system exhibit a property in which a specific frequency range is emphasized. For example, the frequency f₁₁ (=1/(2πT₁₁)) at which the high frequency emphasis starts and the frequency fₛ (=1/(2πTs)) at which the attenuation by nozzles starts are set to be the same to serve as a filter that compensate for the discharge delay. Thus, the discharge delay is compensated, and the occurrence of the speed fluctuation caused by the discrete change of the feeding speed of the fabrication material is restrained. Therefore, the discharge speed has the response property indicated by broken line B in FIG. 13B.

The change in the feeding speed Qᵢₙ₁ before the high frequency emphasis correction is applied is mild compared to the change due to the influence of the discretization. Accordingly, the band of frequencies emphasized by the high-frequency emphasis filter 142 is set to be low, and the band of frequencies attenuated by the high-frequency attenuation filter 143 is set to be high. Therefore, the frequency band emphasized by the high-frequency emphasis filter 142 is lower than the frequency band attenuated by the high-frequency attenuation filter 143.

The frequencies of the high-frequency emphasis filter 142 and the high-frequency attenuation filter 143 may be determined experimentally by dummy fabrication or the like, or may be determined based on physical parameters of a discharger such as the head module 15, physical properties of the fabrication material, or the like.

According to the embodiments of the present disclosure described above, a three-dimensional fabricating apparatus, a three-dimensional fabricating system, a three-dimensional modeling method, and a program that improve the accuracy of a three-dimensional object can be provided.

Each of the functions of the above-described embodiments of the present disclosure can be implemented by a device-executable program written in, for example, C, C++, C#, and Java (registered trademark). The program according to embodiments of the present disclosure can be stored in a device-readable recording medium to be distributed. Examples of the recording medium include a hard disk drive, a compact disk read only memory (CD-ROM), a magneto-optical disk (MO), a digital versatile disk (DVD), a flexible disk, an electrically erasable programmable read-only memory (EEPROM (registered trademark)), and an erasable programmable read-only memory (EPROM). The program can be transmitted over a network in a form with which another computer can execute the program.

Although several embodiments of the present disclosure have been described above, embodiments of the present disclosure are not limited to the above-described embodiments, and various modifications may be made without departing from the spirit and scope of the present disclosure. Such modifications are included within the scope of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present disclosure.

What is claimed is:

1. A three-dimensional fabricating apparatus configured to fabricate a three-dimensional object with a fabrication material fed at a speed component, the three-dimensional fabricating apparatus comprising:
first correction circuitry configured to perform a first correction to emphasize a component in a speed distribution of the speed component;
second correction circuitry configured to perform a second correction to attenuate a component in the speed distribution; and
a discharger configured to discharge the fabrication material fed at a speed based on a corrected speed distribution obtained by the first correction and the second correction.

2. The three-dimensional fabricating apparatus according to claim 1,
wherein the first correction circuitry is configured to emphasize a component having a frequency higher than a first frequency,
wherein the second correction circuitry is configured to attenuate a component having a frequency higher than a second frequency, and
wherein the second frequency is higher than the first frequency.

3. The three-dimensional fabricating apparatus according to claim 2, further comprising a control device configured to determine the first frequency based on a time response characteristic indicating a discharge delay of the fabrication material by the discharger with respect to a speed at which the fabrication material is fed.

4. The three-dimensional fabricating apparatus according to claim 3, further comprising a measuring device configured to measure a discharge amount of the fabrication material discharged by the discharger,
wherein the control device is configured to determine the first frequency based on the discharge amount.

5. The three-dimensional fabricating apparatus according to claim 2, wherein each of the first correction circuitry and the second correction circuitry includes a filter.

6. A three-dimensional fabricating system configured to fabricate a three-dimensional object with a fabrication material fed at a speed component, the three-dimensional fabricating system comprising:
first correction circuitry configured to perform a first correction to emphasize a component in a speed distribution of the speed component;
second correction circuitry configured to perform a second correction to attenuate a component in the speed distribution; and
a discharger configured to discharge the fabrication material fed at a speed based on a corrected speed distribution obtained by the first correction and the second correction.

7. A fabricating method comprising:
fabricating a three-dimensional object with a fabrication material fed at a speed component;
performing a first correction to emphasize a component in a speed distribution of the speed component;
performing a second correction to attenuate a component in the speed distribution; and
discharging the fabrication material fed at a speed based on a corrected speed distribution obtained by the first correction and the second correction.
